(19) United States
(12) Patent Application Publication
(10) Pub. No.: US 2024/0166058 A1
(43) Pub. Date: May 23, 2024

(54) SMART POWER CONTROL APPARATUS AND A METHOD THEREOF

(71) Applicants: HYUNDAI MOTOR COMPANY, Seoul (KR); KIA CORPORATION, Seoul (KR)

(72) Inventor: Jin Yong Kim, Daegu (KR)

(73) Assignees: HYUNDAI MOTOR COMPANY, Seoul (KR); KIA CORPORATION, Seoul (KR)

(21) Appl. No.: 18/228,425

(22) Filed: Jul. 31, 2023

(30) Foreign Application Priority Data
Nov. 22, 2022 (KR) 10-2022-0157443

(51) Int. Cl. B60L 15/20; B60L 58/12; B60L 58/40; H01M 10/44; H01M 16/00

(52) U.S. Cl. CPC B60L 15/2045; B60L 58/12; B60L 58/40; H01M 10/44; H01M 16/006; B60L 2240/642

(57) ABSTRACT

A smart power control apparatus for a commercial hydrogen electric vehicle and a method thereof are provided. The smart power control apparatus includes a navigation device that transmits navigation information; a map providing device that transmits map data including slope information; and a controller connected with the navigation device and the map providing device. The controller determines driving route reliability for a driving route in front of a vehicle based on the navigation information and the slope information and applies at least one of a limit to a battery state of charge (SOC) fluctuation range, an adjustment to a battery charge/discharge rate, or a combination thereof based on the driving route reliability to perform a smart power control.

### CROSS-REFERENCE TO RELATED APPLICATION

This application claims the benefit of and priority to Korean Patent Application No. 10-2022-0157443, filed in the Korean Intellectual Property Office on Nov. 22, 2022, the entire contents of which are incorporated herein by reference.

### TECHNICAL FIELD

The present disclosure relates to a smart power control apparatus for a commercial hydrogen electric vehicle and a method thereof.

### BACKGROUND

When a commercial hydrogen electric vehicle with a large weight (e.g., 40 tons) (e.g., a fuel cell electric vehicle (FCEV)) (e.g., a large hydrogen electric truck or the like) climbs a ramp having a slope (or gradient), motor torque may not be used 100% only by the amount of power generated by the fuel cell stack. Due to this, only when the commercial hydrogen electric vehicle charges a battery state of charge (SOC) to a maximum to travel before going uphill, uphill performance may be ensured. On the other hand, when the commercial hydrogen electric vehicle goes downhill without regenerative braking, it is very dangerous due to heat generation. In other words, the commercial hydrogen electric vehicle may not come down a downhill road with only main braking, needs regenerative braking. It is advantageous for commercial hydrogen electric vehicle to start descending with the battery SOC set to a minimum (MIN). Thus, a smart power control technology for controlling a battery SOC in advance with regard to a current slope in front of the vehicle has been developed.

Because such a smart power control technology takes a long time to charge and discharge the battery, it should control the battery SOC with regard to a forward slope in a very long distance (e.g., 10 km) to be effective in smart power control. After the battery is charged or discharged with regard to a forward downhill slope in a very long distance, when the vehicle enters another driving route rather than an existing driving route, smart power control may cause problems. For example, after a smart power control device charges the battery SOC to a maximum such that the vehicle travels on an uphill road in front of the vehicle, the driving route changes to a downhill road, it may be dangerous because the vehicle is unable to use regenerative braking.

### SUMMARY

The present disclosure has been made to solve the above-mentioned problems occurring in the prior art while advantages achieved by the prior art are maintained intact.

An aspect of the present disclosure provides a smart power control apparatus for performing smart power control by limiting a battery SOC fluctuation range and/or changing a battery charge/discharge rate weight depending on driving route reliability. Thus, a problem in driving does not occur when a vehicle enters another driving route from an existing driving route, when performing the smart power control with regard to a slope of a road ahead far from the vehicle. The present disclosure also provides a method thereof.

The technical problems to be solved by the present disclosure are not limited to the aforementioned problems, and any other technical problems not mentioned herein should be clearly understood from the following description by those having ordinary skill in the art to which the present disclosure pertains.

According to an aspect of the present disclosure, a smart power control apparatus may include a navigation device that transmits navigation information; a map providing device that transmits map data including slope information; and a controller connected with the navigation device and the map providing device. The controller may determine driving route reliability for a driving route in front of a vehicle based on the navigation information and the slope information. The controller may also apply at least one of a limit to a battery state of charge (SOC) fluctuation range, adjustment of a battery charge/discharge rate, or a combination thereof based on the driving route reliability to perform smart power control.

The controller may determine the driving route reliability as a third level, when there is at least one of when the vehicle travels after a destination is set, when there is only a main path on the driving route, when there is no sub-path having a slope opposite to a slope of the main path, or a combination thereof.

The controller may determine the driving route reliability as a second level, when there is at least one of when a slope of a main path on the driving route is identical to a slope of a first-level sub-path branching from the main path but is opposite to a slope of a second-level sub-path branching from the first-level sub-path, when the driving route is a previously stored recurring driving route, or a combination thereof.

The controller may determine the driving route reliability as a first level, when the vehicle travels after a destination is not set, when there is a sub-path branching from a main path on the driving route, when there is a sub-path having a slope opposite to a slope of the main path, when the slope of the main path is not identical to a slope of a first-level sub-path branching from the main path but is not identical to a slope of a second-level sub-path branching from the first-level sub-path, and when the driving route does not correspond to a previously stored recurring driving route.

The controller may calculate SOC consumption according to a slope for each road segment. The controller may also determine to enter a power control mode based on the SOC consumption according to the slope for each road segment. The controller may also determine a required amount of charge using the SOC consumption according to the slope for each road segment. The controller may also calculate an amount of stack power generation using the required amount of charge. The controller may also control charging and discharging of a battery based on the amount of stack power generation.

The controller may determine to enter an uphill condition control mode for power control in an uphill condition, when the SOC consumption according to the slope for each road segment meets an uphill condition control initiation criterion. The controller may also determine to enter a downhill condition control mode for power control in a downhill condition, when the SOC consumption according to the slope for each road segment meets a downhill condition control initiation criterion.

The controller may determine a time point when the vehicle enters a road segment closest to the vehicle among road segments meeting the uphill condition control initiation criterion and the downhill condition control initiation criterion as a power control release time point.

The controller may control a fuel cell controller to adjust the amount of stack power generation based on the amount of stack power generation and may charge the battery with electrical energy generated by a fuel cell stack.

The controller may determine the amount of stack power generation as resistor consumption, when the amount of stack power generation is a negative number.

The controller may control a resistor to consume electrical energy stored in the battery based on the resistor consumption.

According to another aspect of the present disclosure, a smart power control method may include determining driving route reliability for a driving route in front of a vehicle based on navigation information and slope information included in map data. The method may also include applying at least one of a limit to a battery state of charge (SOC) fluctuation range, adjustment of a battery charge/discharge rate, or a combination thereof based on the driving route reliability to perform smart power control.

The determining of the driving route reliability may include determining the driving route reliability as a third level, when there is at least one of when the vehicle travels after a destination is set, when there is only a main path on the driving route, when there is no sub-path having a slope opposite to a slope of the main path, or a combination thereof.

The determining of the driving route reliability may include determining the driving route reliability as a second level, when there is at least one of when a slope of a main path on the driving route is identical to a slope of a first-level sub-path branching from the main path but is opposite to a slope of a second-level sub-path branching from the first-level sub-path, when the driving route is a previously stored recurring driving route, or a combination thereof.

The determining of the driving route reliability may include determining the driving route reliability as a first level, when the vehicle travels after a destination is not set, when there is a sub-path branching from a main path on the driving route, when there is a sub-path having a slope opposite to a slope of the main path, when the slope of the main path is not identical to a slope of a first-level sub-path branching from the main path but is not identical to a slope of a second-level sub-path branching from the first-level sub-path, and when the driving route does not correspond to a previously stored recurring driving route.

The controlling of the smart power control may include calculating SOC consumption according to a slope for each road segment. The controlling of the smart power control may also include determining to enter a power control mode based on the SOC consumption according to the slope for each road segment. The controlling of the smart power control may also include determining a required amount of charge using the SOC consumption according to the slope for each road segment. The controlling of the smart power control may also include calculating an amount of stack power generation using the required amount of charge. The controlling of the smart power control may also include controlling charging and discharging of a battery based on the amount of stack power generation.

The determining to enter the power control mode may include determining to enter an uphill condition control mode for power control in an uphill condition, when the SOC consumption according to the slope for each road segment meets an uphill condition control initiation criterion. The determining to enter the power control mode may also include determining to enter a downhill condition control mode for power control in a downhill condition, when the SOC consumption according to the slope for each road segment meets a downhill condition control initiation criterion.

The determining to enter the power control mode may further include determining a time point when the vehicle enters a road segment closest to the vehicle among road segments meeting the uphill condition control initiation criterion and the downhill condition control initiation criterion as a power control release time point.

The controlling of the charging and discharging of the battery may include controlling a fuel cell controller to adjust the amount of stack power generation based on the amount of stack power generation and charging the battery with electrical energy generated by a fuel cell stack.

The calculating of the amount of stack power generation may include determining the amount of stack power generation as resistor consumption, when the amount of stack power generation is a negative number.

The controlling of the charging and discharging of the battery may include controlling a resistor to consume electrical energy stored in the battery based on the resistor consumption.

### BRIEF DESCRIPTION OF THE DRAWINGS

The above and other objects, features, and advantages of the present disclosure should be more apparent from the following detailed description taken in conjunction with the accompanying drawings:

FIG. 1 is a block diagram illustrating a configuration of a smart power control apparatus according to embodiments of the present disclosure;

FIG. 2 is a drawing illustrating an example of tuning a state of charge (SOC) fluctuation range according to embodiments of the present disclosure;

FIG. 3 is a flowchart illustrating a method for determining reliability of a driving route according to embodiments of the present disclosure;

FIG. 4 is a flowchart illustrating a smart power control method according to embodiments of method present disclosure; and

FIG. 5 is a block diagram illustrating a computing system for executing a smart power control method according to embodiments of the present disclosure.

### DETAILED DESCRIPTION

Hereinafter, some embodiments of the present disclosure are described in detail with reference to the drawings. In the drawings, the same reference numerals are used throughout to designate the same or equivalent elements. In addition, a detailed description of well-known features or functions has been ruled out in order not to unnecessarily obscure the gist of the present disclosure.

In describing the components of the embodiment according to the present disclosure, terms such as first, second, “A”, “B”, (a), (b), and the like may be used. These terms are only used to distinguish one element from another element and do not limit the corresponding elements irrespective of the order or priority of the corresponding elements. Furthermore, unless otherwise defined, all terms including technical and scientific terms used herein should be interpreted as is customary in the art to which the present disclosure belongs. Such terms as those defined in a generally used dictionary should be interpreted as having meanings equal to the contextual meanings in the relevant field of art and should not be interpreted as having ideal or excessively formal meanings unless clearly defined as having such in the present application. When a component, device, element, or the like of the present disclosure is described as having a purpose or performing an operation, function, or the like, the component, device, element, or the like should be considered herein as being “configured to” meet that purpose or to perform that operation or function. Each of the component, device, element, and the like may separately embody or be included with a processor and a memory, such as a non-transitory computer readable media, as part of the apparatus.

The specification may present a method for limiting an amount of change in target battery state of charge (SOC) (or a battery SOC fluctuation range) based on reliability of a driving route of a vehicle or changing a battery charge/discharge rate weight to minimize a driving problem caused by smart power control. Reliability of the driving route (or route reliability) refers to reliability of slope information of a current driving route, which is received by smart power control logic. When slope information is similar although the driving route is changed, for example, when the slope information changes from uphill to uphill, it may be determined that reliability is high. When it is possible to reverse slope information from uphill to downhill due to a change in route, it may be determined that reliability is low.

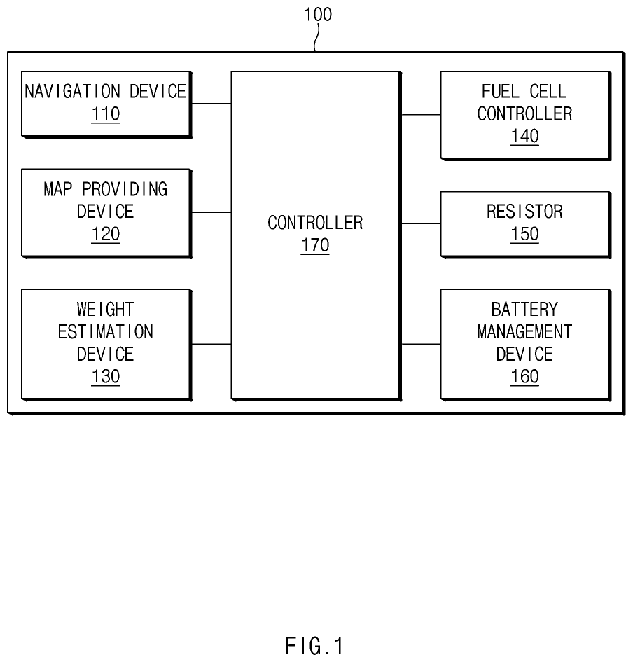

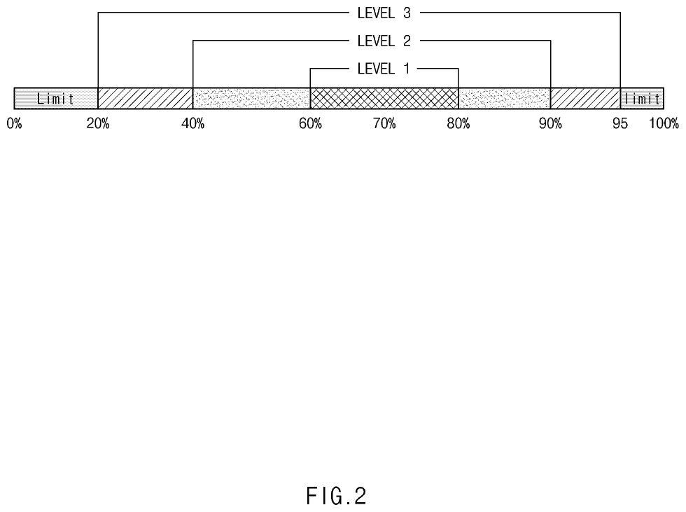

FIG. 1 is a block diagram illustrating a configuration of a smart power control apparatus according to embodiments of the present disclosure. FIG. 2 is a drawing illustrating an example of tuning an SOC fluctuation range according to embodiments of the present disclosure.

A smart power control apparatus 100 may be mounted on a commercial hydrogen electric vehicle, such as a large hydrogen electric truck or the like. The smart power control apparatus 100 may perform power control of a vehicle with regard to road slope information at a point away from the vehicle over a predetermined distance (e.g., 10 km) in front of the vehicle.

The smart power control apparatus 100 may include a navigation device 110, a map providing device 120, a weight estimation device 130, a fuel cell controller 140, a resistor 150, a battery management device 160, and a controller 170.

The navigation device 110 may transmit vehicle information, road information, a recurring driving route information, and/or the like. The vehicle information may include a vehicle speed or the like. The road information may include a vehicle share for each road, traffic volume for each road, and a speed for each road. The recurring driving route information may be a route registered by a user or a route automatically registered due to recurring driving a predetermined number of times or more.

Furthermore, when a destination is entered through a user interface (e.g., a touch screen or the like), the navigation device 110 may navigate (or search for) a driving route from a starting point (e.g., a current location of the vehicle or a specific point determined by the user) to the destination and may guide the user along the driving route. When navigating the driving route, the navigation device 110 may reflect real-time traffic information to search for an optimal route (e.g., a shortest distance route, a minimum time route, and/or the like). Although not illustrated in the drawing, the navigation device 110 may include a global positioning system (GPS) receiver for measuring a vehicle location, a communication circuit for receiving traffic information from the outside, a display for displaying map data and a driving route, a processor for navigating a driving route and guiding the user along the navigated driving route, and/or the like. The navigation device 110 may further include a memory, which stores instructions executed by the processor and/or map data.

The map providing device 120 may transmit high definition map data based on the driving route transmitted from the navigation device 110. Herein, the high definition map data may be map data for supporting an advanced driver assistance system (ADAS) (hereinafter referred to as “ADAS map data”). When there is an intersection on a main path, the map providing device 120 may generate a stub and may transmit sub-path information. Although not illustrated in the drawing, the map providing device 120 may include a processor for controlling the overall operation of the map providing device 120 and a memory for storing logic (or instructions) or the like executed by the processor. The ADAS map data may be stored in the memory or may be stored in a separate memory.

The weight estimation device 130 may estimate and output a weight of the vehicle. The weight estimation device 130 may estimate the weight of the vehicle using a well-known vehicle weight estimation technology. For example, the weight estimation device 130 may calculate the weight of the vehicle using driving information of the vehicle, for example, a vehicle speed and/or elevation data. The present embodiment describes that the weight estimation device 130 is provided independently, but not limited thereto. As an example, the controller 170 may be implemented to estimate the weight of the vehicle using the weight estimation logic stored in the memory.

The fuel cell controller 140 may control power generation of a fuel cell stack (hereinafter referred to as a “stack”) depending on a command of the controller 170. In other words, the fuel cell controller 140 may adjust an amount of power generation of the stack under an instruction of the controller 170. The stack may generate electrical energy by an electrochemical reaction between hydrogen and oxygen. The stack may include two catalyst electrodes, i.e., an anode and a cathode. When hydrogen and oxygen are respectively supplied to the anode and the cathode (or an air electrode), the anode may divide the hydrogen into protons, i.e., hydrogen ions and electrons. The hydrogen ions may move to the cathode through an electrolyte layer and may be combined with oxygen in the cathode to produce water. The electrical energy generated by the stack may be stored in a high voltage battery (not shown) of the vehicle or may be directly supplied to a drive motor (not shown).

The resistor 150 may consume (or use) the electrical energy stored in a vehicle battery (or the high voltage battery) depending on the command of the controller 170. The battery may be discharged due to the consumption of the electrical energy of the resistor 150.

The battery management device 160 may serve to optimally manage a state of charge (SOC) of the vehicle battery to increase energy efficiency. Such a battery management device 160 may be implemented as a battery management system (BMS). The battery management device 160 may monitor a voltage, a current, a temperature, and/or the like of the vehicle battery using sensors (e.g., a current sensor, a voltage sensor, and/or a temperature sensor). The battery management device 160 may prevent the vehicle battery from being overcharged or overdischarged by means of the monitoring. Furthermore, the battery management device 160 may calculate an SOC of the vehicle battery (or a battery SOC) using the current, the voltage, and/or the like measured by the sensors. The vehicle battery may supply power to an electrical device, for example, an electronic control unit (ECU), a drive motor (or a power source), and/or the like, which is loaded into the vehicle.

The controller 170 may be electrically connected with the respective components 110 to 160. The controller 170 may control the overall operation of the smart power control apparatus 100. The controller 170 may be implemented as a vehicle control unit (VCU). The controller 170 may include a processor and a memory. The processor may be implemented as at least one of an application specific integrated circuit (ASIC), a digital signal processor (DSP), a programmable logic device (PLD), a field programmable gate array (FPGA), a central processing unit (CPU), a microcontroller, a microprocessor, or a combination thereof. The memory may be a non-transitory storage medium, which stores instructions executed by the processor. The memory may be implemented as at least one of a flash memory, a hard disk, a solid state disk (SSD), a secure digital (SD) card, a random access memory (RAM), a static RAM (SRAM), a read only memory (ROM), a programmable ROM (PROM), an electrically erasable and programmable ROM (EEPROM), an erasable and programmable ROM (EPROM), or a combination thereof. When the vehicle starts to travel, the processor may execute route reliability determination logic and smart power control logic stored in the memory. Furthermore, the processor may include a communication circuit which performs wired and/or wireless communication with the respective components 110 to 160.

The controller 170 may determine reliability of the driving route (or driving route reliability) of the vehicle depending on the route reliability determination logic. The controller 170 may determine route reliability from the vehicle to predetermined x road segments based on the driving route. The controller 170 may deliver the driving route reliability determined by the route reliability determination logic as input data of the smart power control logic.

The controller 170 may receive the navigation information from the navigation device 110 and may receive the driving route information from the map providing device 120. The navigation information may include whether a destination is entered (or whether the destination is set) or the like. The driving route information may include ADAS map data matched with the driving route.

The controller 170 may determine driving route reliability based on the navigation information or the navigation information and the driving route information. The controller 170 may determine the driving route reliability as a third level, when the driving route reliability is highest. The controller 170 may also determine the driving route reliability as a second level, when the driving route reliability has some degree but is lower than the third level. The controller 170 may also determine the driving route reliability as a first level, when the driving route reliability is lowest, i.e., there is no reliability. The case where the driving route reliability is divided into the three levels is described in the present embodiment but is not limited thereto. The driving route reliability may be subdivided into four or more levels for more precise power control.

As an example, when a first condition is met, the controller 170 may determine the driving route reliability as the third level. The first condition may be the case where the vehicle travels after the destination is set. When the user (e.g., the driver) enters a destination using a user interface provided by the navigation device 110 and drives the vehicle, because he or she mostly drives along a driving route guided by the navigation device 110, the controller 170 may determine the driving route reliability as the third level.

As another example, when a second condition is met, the controller 170 may determine the driving route reliability as the third level. The second condition may be the case where there is no sub-path on the current driving route, i.e., there is only a main path on the driving route. When there is no sub-path on the driving route, because a possibility that the route will change is close to “0”, the controller 170 may determine the driving route reliability as the third level. The main path may be the driving route, and the sub-path may be a path branching from the main path. For example, the controller 170 may recognize a path forking at an intersection on the main path as a sub-path.

As another example, when a third condition is met, the controller 170 may determine the driving route reliability as the third level. The third condition may be the case where there is no sub-path having a slope opposite to the main path on a current driving route. For example, although there is a sub-path, when both the main path and the sub-path are uphill or when both the main path and the sub-path are downhill, the controller 170 may determine the driving route reliability as the third level. The case where there is a problem when maximally charging or discharging the battery using the smart power control technology may be a situation where the slope changes from uphill to downhill or changes from downhill to uphill as the driving route changes. Thus, unless opposite gradient information for the main path and the sub-path is transmitted, the controller 170 may determine the driving route reliability as the third level.

As another example, when a fourth condition is met, the controller 170 may determine the driving route reliability as the second level. The fourth condition may be the case where the slope of the main path is identical to the slope of a first-level sub-path on the current driving route, but the slope opposite to the slope of the main path is included in a second-level sub-path. Herein, the first-level sub-path may be a path branching from the main path, and the second-level sub-path may be a path branching from the first-level sub-path. For example, when the slope information of the current driving route, i.e., the main path, is identical to the slope information of the first-level sub-path, but the slope information of the second-level sub-path is opposite to the slope information of the main path, because it is able to determine that the vehicle will travel at the same slope as the main path before the vehicle enters the first-level sub-path including the second-level sub-path, the controller 170 may determine the driving route reliability as the second level.

As another example, when a fifth condition is met, the controller 170 may determine the driving route reliability as the second level. The fifth condition may be the case where the vehicle travels on a previously stored recurring driving route. Due to the nature of a commercial vehicle, because the commercial vehicle often drives on the same driving route repeatedly, a driver may directly store the recurring driving route. Alternatively, when driving with smart power control at the first level and when the situation where the SOC enters the restricted area n times, the moment when the SOC enters the restricted area for the nth time may be automatically stored as a moment point of interest (POI). When the main path includes a driving route and/or a POI stored manually or automatically, the controller 170 may determine the driving route reliability as the second level.

When the first to fifth conditions are not met, the controller 170 may determine the driving route reliability as the first level. In other words, when the first to fifth conditions are not met, the controller 170 may determine that there is no driving route reliability. Thus, because a problem may occur when the vehicle changes a route to travel during power control with smart power control, the controller 170 may limit an SOC fluctuation range changed with the smart power control to a minimum.

The controller 170 may determine a battery SOC fluctuation range (or a battery SOC control range) based on the driving route reliability. Referring to FIG. 2, assuming that a target SOC is 70% when smart power control is not performed, the controller 170 may limit the battery SOC fluctuation range from 60% to 80%, which is ±10% with respect to the target SOC when the driving route reliability is the first level. When the driving route reliability is the second level, the controller 170 may limit the battery SOC fluctuation range from 40% to 90%. When the driving route reliability is the third level, the controller 170 may limit the battery SOC fluctuation range from 20% to 95%. The battery SOC control range according to the level of the driving route reliability may be a previously tuned value.

The controller 170 may variably tune an uphill weight or a downhill weight based on the driving route reliability information. For example, when the driving route reliability is the third level, the controller 170 may set the uphill weight or the downhill weight to 1.5 and may quickly increase a battery charge/discharge rate. When the driving route reliability is the second level, the controller 170 may set the uphill weight or the downhill weight to 1.0 to set the battery charge/discharge rate to a default value. When the driving route reliability is the first level, the controller 170 may set the uphill weight or the downhill weight to 0.5 and may slowly decrease the battery charge/discharge rate.

The controller 170 may select and apply at least one of a limit to the battery SOC fluctuation range, adjustment of the battery charge/discharge rate (or a change in battery charge/discharge rate), or a combination thereof to smart power control.

The controller 170 may receive the input signal (or the input data) transmitted from the navigation device 110, the map providing device 120, the weight estimation device 130, the fuel cell controller 140, and the battery management device 160. The controller 170 may receive input data such as vehicle information, road information, and recurring driving route information transmitted from the navigation device 110. The vehicle information may include a vehicle speed. The road information may include traffic volume for each road, a vehicle share for each road, and a speed for each road. The controller 170 may receive ADAS map data based on the driving route set by the navigation device 110 from the map providing device 120. The ADAS map data may include slope information for each road segment, a length for each road segment, a distance from the vehicle to each road segment end point, and/or the like. The road segment may be divided around a point where the road slope changes. In other words, the slope in the road segment may be constant within a predetermined acceptable range. The controller 170 may receive vehicle weight information (or a vehicle estimation weight) estimated from the weight estimation device 130. The controller 170 may receive fuel cell information including a current amount of stack power generation or the like from the fuel cell controller 140. The controller 170 may receive battery information including a current battery SOC or the like from the battery management device 160.

The controller 170 may determine whether the input signal is normally received. For example, the controller 170 may determine whether there is an error in reception due to a communication failure or the like with the respective components 110 to 160.

The controller 170 may calculate SOC consumption for each road segment. The controller 170 may calculate SOC consumption for each road segment using a vehicle dynamics formula.

When the vehicle travels at the current speed, because driving resistance is “0”, Equation 2 below may be represented when Equation 1 below is rearranged.

$$ma = {F}_{traction} - ( {F}_{drag} + {F}_{roll} + {F}_{grade} ) \qquad [ Equation 1 ]$$

Herein, m denotes the vehicle weight, a denotes the acceleration of the vehicle, F_{traction} denotes the traction, F_{drag} denotes the air drag, Fᵣₒₗₗ denotes the rolling resistance, and F_{grade} denotes the gradeability.

$${F}_{traction} = {F}_{drag} + {F}_{roll} + {F}_{grade} = 0.5 * ρ * {C}_{d} * A * {V}^{2} + mg * ( {C}_{r} cos θ + sin θ ) \qquad [ Equation 2 ]$$

Herein, ρ denotes the air density, C_{d} denotes the air resistance coefficient, A denotes the front area, and Cᵣ denotes the rolling resistance coefficient.

The SOC consumption for each road segment may be represented as Equation 3 below.

$$S O {C}_{seg} = {F}_{traction} * {L}_{seg} \qquad [ Equation 3 ]$$

Herein, L_{seg} denotes the length of the road segment.

The controller 170 may calculate only SOC consumption caused by a slope for each road segment for logic simplification. SOC consumption SOC_{grade} caused by the slope for each road segment may be represented as Equation 4 below.

$$S O {C}_{grade} = mg * sin θ * {L}_{seg} \qquad [ Equation 4 ]$$

Herein, g denotes the acceleration of gravity.

For example, assuming that the vehicle weight is 40,000 kg and the vehicle speed is 80 kph (=22.2 m/s), SOC consumption caused by a slope of a first road segment is 0 kwh when the slope and the length of the first road segment are 0% and 2,000 m, SOC consumption caused by a slope of a second road segment is 7.6 kwh when the slope and the length of the second road segment are 2% and 1,000 m, SOC consumption caused by a slope of a third road segment is 2.85 kwh when the slope and the length of the third road segment are 1% and 1,500 m, SOC consumption caused by a slope of a fourth road segment is −11 kwh when the slope and the length of the fourth road segment are −3% and 2,000 m, and SOC consumption caused by a slope of a fifth road segment is −7.59 kwh when the slope and the length of the fifth road segment are −4% and 1,000 m.

The controller 170 may determine power control entry or release for driving on a ramp using an SOC change value caused by a slope for each road segment in front of the vehicle. When the SOC consumption for each road segment meets a first uphill condition control initiation criterion and a second uphill condition control initiation criterion, the controller 170 may determine to enter an uphill condition control mode. The first uphill condition control initiation criterion and the second uphill condition control initiation criterion may be criteria for determining whether to enter a power control mode for power control in the uphill condition and may be set by a system designer in advance.

For example, when the sum of SOC consumption for each road segment, i.e., the sum of SOC consumption in first to fifth road segments is greater than the first uphill condition control initiation criterion and when SOC consumption in the fifth road segment, the sum of SOC consumption in the fourth road segment and the fifth road segment, the sum of SOC consumption in the third to fifth road segments, or the sum of SOC consumption in the second to fifth road segments is greater than the second uphill condition control initiation criterion, the controller 170 may determine to enter the uphill condition control mode.

Furthermore, when the SOC consumption for each road segment meets the first downhill condition control initiation criterion and the second downhill condition control initiation criterion, the controller 170 may determine to enter a downhill condition control mode. For example, when the sum of SOC consumption for each road segment is less than the first downhill condition control initiation criterion and when SOC consumption in the fifth road segment, the sum of SOC consumption in the fourth road segment and the fifth road segment, the sum of SOC consumption in the third to fifth road segments, or the sum of SOC consumption in the second to fifth road segments is less than the second downhill condition control initiation criterion, the controller 170 may determine to enter the downhill condition control mode.

The first uphill condition control initiation criterion and the first downhill condition control initiation criterion need a little tuning, and the second uphill condition control initiation criterion and the second downhill condition control initiation criterion need a sufficient high input to enter the power control mode on an uphill or downhill over a predetermined length.

Furthermore, when the power control release time point is reached, the controller 170 may release the uphill condition control or the downhill condition control. When the road segment information is updated, the power control release time point may change. Thus, the power control release time point may be continuously updated on a long ramp. For example, when the controller 170 enters the power control mode by SOC consumption in the fifth road segment, the fifth road segment entry time point may be a power control logic release time point. Furthermore, when the controller 170 enters the power control mode by the sum of SOC consumption in the fourth road segment and the fifth road segment, the fourth road segment entry time point may be a power control logic release time point. When the controller 170 enters the power control mode by the sum of SOC consumption in the third to fifth road segments, the third road segment entry time point may be the power control release time point. When the controller 170 enters the power control mode by the sum of SOC consumption in the second to fifth road segments, the second road segment entry time point may be the power control mode release time point. Herein, the road segment may be defined as the first road segment, the second road segment, the third road segment, the fourth road segment, and the fifth road segment sequentially starting from the road segment closest to the vehicle.

When the controller 170 enters the power control mode, the controller 170 may determine the amount of charge (or the required amount of charge) according to the road slope. At this time, the controller 170 may determine a required amount of charge (or an amount of charge required) without regard to an SOC limit by the driving route reliability. Furthermore, the controller 170 may determine the required amount of charge with regard to the SOC limit by the driving route reliability. The SOC limit by the driving route reliability may be a value tuned in advance, which may include an SOC upper limit and an SOC lower limit depending on the driving route reliability. For example, the SOC upper limit and the SOC lower limit may be 80% and 60%, respectively, when the driving route reliability is the first level, the SOC upper limit and the SOC lower limit may be 90% and 45%, respectively, when the driving route reliability is the second level, and the SOC upper limit and the SOC lower limit may be 95% and 20%, respectively, when the driving route reliability is the third level. In other words, when the battery capacity is 50 kwh, the SOC upper limits according to the driving route reliability may be 40 kwh, 45 kwh, and 47.5 kwh, and the SOC lower limits may be kwh, 20 kwh, and 10 kwh.

First of all, when determining the required amount of charge without regard to the SOC limit by the driving route reliability, the controller 170 may determine the required amount of charge Uphill_SOC_added as total SOC consumption Uphill_Soc_Total for uphill in the uphill condition. Herein, the total SOC consumption Uphill_Soc_Total for uphill may be defined as the sum of SOC consumption for each road segment, which meets the uphill condition control initiation criterion, i.e., the sum of SOC consumption for each uphill segment. Meanwhile, the controller 170 may determine the required amount of charge Downhill_SOC_added as total SOC consumption for downhill in the downhill condition. Herein, the total SOC consumption Downhill_Soc_Total for downhill may be defined as the sum of SOC consumption for each road segment, which meets the downhill condition control initiation criterion, i.e., the sum of SOC consumption for each downhill segment.

Next, when determining the required amount of charge with regard to SOC limits High_Limit and Low_Limit by the driving route reliability, the controller 170 may determine the required amount of charge in the uphill condition based on the SOC upper limit High_Limit. When the sum of the battery SOC Bat_SOC and the total SOC consumption Uphill_Soc_Total for uphill is less than or equal to the SOC upper limit, the controller 170 may determine the required amount of charge Uphill_SOC_added in the uphill condition as the total SOC consumption Uphill_Soc_Total for uphill. Meanwhile, when the sum of the battery SOC Bat_SOC and the total SOC consumption Uphill_Soc_Total for uphill is greater than the SOC upper limit, the controller 170 may calculate the required amount of charge Uphill_SOC_added in the uphill condition using Equation 5 below.

Uphill_SOC_added=High_Limit−Bat_SOC [Equation 5]

Furthermore, the controller 170 may determine the required amount of charge Downhill_SOC_added in the downhill condition based on the SOC limit Low_Limit. When the sum of the battery SOC Bat_SOC and the total SOC consumption Uphill_Soc_Total for uphill is greater than or equal to the SOC lower limit, the controller 170 may determine the required amount of charge Downhill_SOC_added in the downhill condition as the total SOC consumption Downhill_Soc_Total for downhill. Meanwhile, when the sum of the battery SOC Bat_SOC and the total SOC consumption Uphill_Soc_Total for uphill is less than the SOC lower limit, the controller 170 may calculate the required amount of charge Downhill_SOC_added in the downhill condition using Equation 6 below. Because the required amount of charge in the downhill condition is output as (−) value, it is a value which should be discharged. In other words, the required amount of charge in the downhill condition may refer to a required amount of discharge.

$$Downhill\_SOC \_added = Low\_Limit - Bat\_SOC \qquad [ Equation 6 ]$$

As an example, in a state where the maximum battery charge SOC is 50 kwh (100%) in the uphill condition, the current battery SOC is 35 kwh, and the sum Uphill_Soc_Total of SOC consumption for each uphill segment is 12 kwh, when the driving route reliability is the first level, the SOC upper limit High_Limit may be determined as 80% of the maximum battery charge SOC, 40 kwh. At this time, because the value (47 kwh=35 kwh+12 kwh) obtained by adding the battery SOC and the sum of SOC consumption for each uphill segment is greater than the SOC upper value, the required amount of charge may be determined as 5 kwh (=40-35).

As another example, in a state where the maximum battery charge SOC is 50 kwh (100%) in the uphill condition, the current battery SOC is 35 kwh, and the sum Uphill_Soc_Total of SOC consumption for each uphill segment is 12 kwh, when the driving route reliability is the third level, the SOC upper limit High_Limit may be determined as 95% of the maximum battery charge SOC, 47.5 kwh. At this time, because the value (47 kwh=35 kwh+12 kwh) obtained by adding the battery SOC and the sum of SOC consumption for each uphill segment is less than the SOC upper value, the required amount of charge may be determined as the sum Uphill_Soc_Total of SOC consumption for each uphill segment, 12 kwh.

As another example, in a state where the maximum battery charge SOC is 50 kwh in the downhill condition, the current battery SOC is 35 kwh (70%), and the sum Downhill_Soc_Total of SOC consumption for each downhill segment is −20 kwh, when the driving route reliability is the first level, the SOC lower limit Low_Limit may be determined as 60% of the maximum battery charge SOC, 30 kwh. In this case, when the value (15 kwh=35 kwh−20 kwh) obtained by adding the current battery SOC and the sum Downhill_Soc_Total of SOC consumption for each downhill segment is less than the SOC lower value Low_Limit, the required amount of charge may be determined as −5 kwh (=30-35). Because the required amount of charge is −5 kwh, it may mean that a discharge of 5 kwh is required.

As another example, in a state where the maximum battery charge SOC is 50 kwh in the downhill condition, the current battery SOC is 35 kwh (70%), and the sum Downhill_Soc_Total of SOC consumption for each downhill segment is −20 kwh, when the driving route reliability is the third level, the SOC lower limit Low_Limit may be determined as 20% of the maximum battery charge SOC, 10 kwh. In this case, when the value (15 kwh=35 kwh−20 kwh) obtained by adding the current battery SOC and the sum Downhill_Soc_Total of SOC consumption for each downhill segment is greater than the SOC lower limit, the required amount of charge may be determined as the sum Downhill_Soc_Total of SOC consumption for each downhill segment, −20 kwh. This may mean that a discharge of 20 kwh is required. When entering the power control mode, the controller 170 may calculate an amount of stack power generation and resistor consumption.

The controller 170 may calculate an amount Gᵤₚₕᵢₗₗ of stack power generation in the uphill condition. The amount Gᵤₚₕᵢₗₗ of stack power generation in the uphill condition may be represented as Equation 7 below.

$${G}_{uphill} = {G}_{FCU \_ origin} + {W}_{uphill} * ( Uphill\_SOC \_added / ( {D}_{uphill} / ( V / 3.6 ) ) ) \qquad [ Equation 7 ]$$

Herein, G_{FCU_origin} denotes the current amount of power generation of the fuel cell stack, Wᵤₚₕᵢₗₗ denotes the weight when calculating the amount of power generation in the uphill condition, Dᵤₚₕᵢₗₗ denotes the distance between the current vehicle and the start point of the road segment meeting the uphill condition control initiation criterion, and V denotes the vehicle speed.

The controller 170 may calculate an amount G_{downhill} of stack power generation in the downhill condition. The amount G_{downhill} of stack power generation in the downhill condition may be represented as Equation 8 below.

$${G}_{downhill} = {G}_{FCU \_ origin} + {W}_{downhill} * ( Downhill\_SOC \_added / ( {D}_{downhill} / ( V / 3.6 ) ) ) \qquad [ Equation 8 ]$$

Herein, G_{FCU_origin} denotes the current amount of power generation of the fuel cell stack, W_{downhill} denotes the weight when calculating the amount of power generation in the downhill condition, D_{downhill} denotes the distance between the current vehicle and the start point of the road segment meeting the downhill condition control initiation criterion, and V denotes the vehicle speed.

Wᵤₚₕᵢₗₗ and W_{downhill} may be variably tuned based on the level information of the driving route reliability, which is received from reliability determination logic.

When the amount G_{downhill} of stack power generation in the downhill condition is a negative number less than “0”, the controller 170 may determine the amount G_{downhill} of power generation in the downhill condition as resistor consumption. In other words, when the amount G_{downhill} of stack power generation in the downhill condition is − value, the controller 170 may discharge electrical energy of the vehicle battery by means of the resistor 150.

Thereafter, the controller 170 may deliver the determined amount of stack power generation to the fuel cell controller 140. The fuel cell controller 140 may adjust the amount of power generation of the fuel cell stack based on the determined amount of stack power generation. When the battery SOC reaches the SOC limit according to the driving route reliability by the power generation of the fuel cell stack, the controller 170 may release the power control.

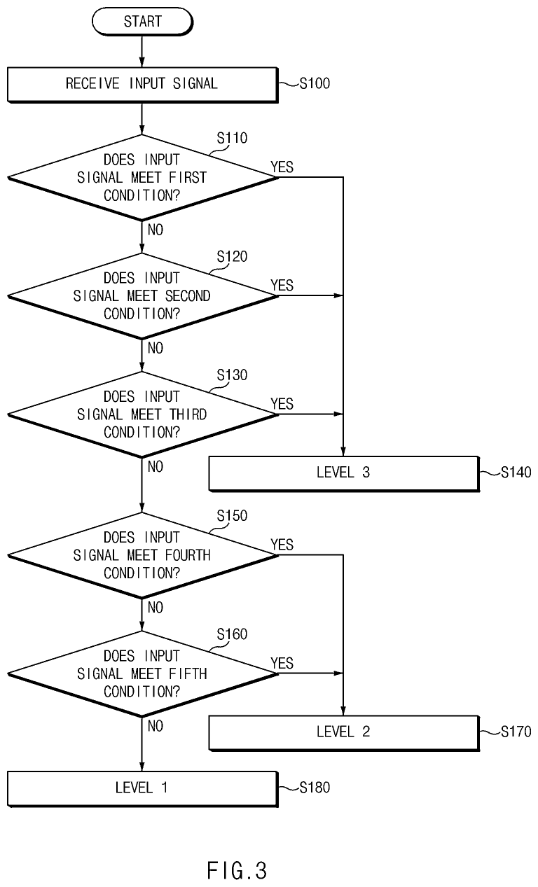

FIG. 3 is a flowchart illustrating a method for determining reliability of a driving route according to embodiments of the present disclosure.

In S100, a controller 170 of FIG. 1 may receive an input signal from a navigation device 110 and a map providing device 120 of FIG. 1. When a vehicle starts to travel, the controller 170 may execute route reliability determination logic stored in a memory. The controller 170 may receive information about whether a destination is entered (or whether the destination is set), i.e., navigation information from the navigation device 110. Furthermore, the controller 170 may receive ADAS map data based on a driving route from the map providing device 120. The ADAS map data may include a curvature of the road, a gradient, a sign, lane information, and/or the like.

In S110, the controller 170 may determine whether the input signal meets a first condition. The controller 170 may identify whether the destination is entered, which is received from the navigation device 110. When it is identified that the destination is entered, the controller 170 may determine that the first condition is met. Meanwhile, when it is identified that the destination is not entered, the controller 170 may determine that the first condition is not met.

When the input signal does not meet the first condition (No in S110), in S120, the controller 170 may determine whether the input signal meets a second condition. The controller 170 may identify whether there is only a main path without a sub-path on the driving route. When it is identified that there is only the main path, the controller 170 may determine that the second condition is met. Meanwhile, when it is identified that there is a sub-path branching from the main path on the driving route, the controller 170 may determine that the second condition is not met.

When the input signal does not meet the second condition (No in S120), in S130, the controller 170 may determine whether the input signal meets a third condition. When there is the sub-path, the controller 170 may identify whether there is a sub-path having a slope opposite to the slop of the main path on the driving route. When it is identified that there is no sub-path having the slope opposite to the slope of the main path, the controller 170 may determine that the third condition is met. Meanwhile, when it is identified that there is the sub-path having the slope opposite to the slope of the main path, the controller 170 may determine that the third condition is not met. For example, when an uphill road is included in the main path, the controller 170 may identify whether there is a sub-path including a downhill road among sub-paths. The controller 170 may determine that the third condition is met, when there is no sub-path including the downhill road, and the controller 170 may determine that the third condition is not met, when there is the sub-path including the downhill road.

When the first condition, the second condition, or the third condition is met (Yes in S110, S120, or S130), in S140, the controller 170 may determine reliability of the driving route as level 3 (or the third level). Herein, level 3 may correspond to when the driving route reliability is highest.

When the input signal does not meet the third condition (No in S130), in S150, the controller 170 may determine whether the input signal meets a fourth condition. The controller 170 may compare the slope of the main path with a slope of a first-level sub-path and a second-level sub-path. When the slope of the main path is identical to the slope of the first-level sub-path but is not identical to the slope of the second-level sub-path, the controller 170 may determine that the fourth condition is met. Meanwhile, when the slope of the main path is not identical to the slope of the first-level sub-path and is not identical to the second-level sub-path, the controller 170 may determine that the fourth condition is not met. The first-level sub-path may be a path branching from the main path, and the second-level sub-path may be a path branching from the first-level sub-path.

When the input signal does not meet the fourth condition (No in S150), in S160, the controller 170 may determine whether the input signal meets a fifth condition. The controller 170 may identify whether the driving route is a previously stored recurring driving route. When it is identified that the driving route is the previously stored recurring driving route, the controller 170 may determine that the fifth condition is met. Meanwhile, when it is identified that the driving route is not the previously stored recurring driving route, the controller 170 may determine that the fifth condition is not met.

When the fourth condition or the fifth condition is met (Yes in S150 or S160), S170, the controller 170 may determine the driving route reliability as level 2 (or the second level). Herein, level 2 may correspond to when the driving route reliability has some degree but is lower than the third level.

When the fifth condition is not met in S160 (No in S160), S180, the controller 170 may determine the driving route reliability as level 1 (or the first level). In other words, when all the first to fifth conditions are not met, the controller 170 may determine the driving route reliability as level 1. Level 1 may correspond to when the driving route reliability is lowest, i.e., when there is no reliability.

Thereafter, the controller 170 may determine a battery SOC fluctuation range, i.e., a battery SOC control range based on the determined driving route reliability. Assuming that a target SOC is 70% when power control based on the road slope is not performed, the controller 170 may limit the battery SOC fluctuation range from 60% to 80%, which is ±10% with respect to the target SOC when the driving route reliability is level 1. When the driving route reliability is level 2, the controller 170 may limit the battery SOC fluctuation range from 40% to 90%. When the driving route reliability is level 3, the controller 170 may limit the battery SOC fluctuation range from 20% to 95%. The battery SOC control range according to the level of the driving route reliability may be previously tuned through an experiment or the like.

Furthermore, the controller 170 may variably adjust a battery charge/discharge rate weight (i.e., an uphill weight or a downhill weight) based on the determined driving route reliability. For example, when the driving route reliability is level 3, the controller 170 may set the uphill weight or the downhill weight to 1.5 and may quicken a battery charge/discharge rate. When the driving route reliability is level 2, the controller 170 may set the uphill weight or the downhill weight to 1.0 to set the battery charge/discharge rate to a default value. When the driving route reliability is level 1, the controller 170 may set the uphill weight or the downhill weight to 0.5 and may slowly decrease the battery charge/discharge rate.

The controller 170 may select at least one of a limit to the battery SOC fluctuation range, adjustment of the battery charge/discharge rate, or a combination thereof to perform smart power control.

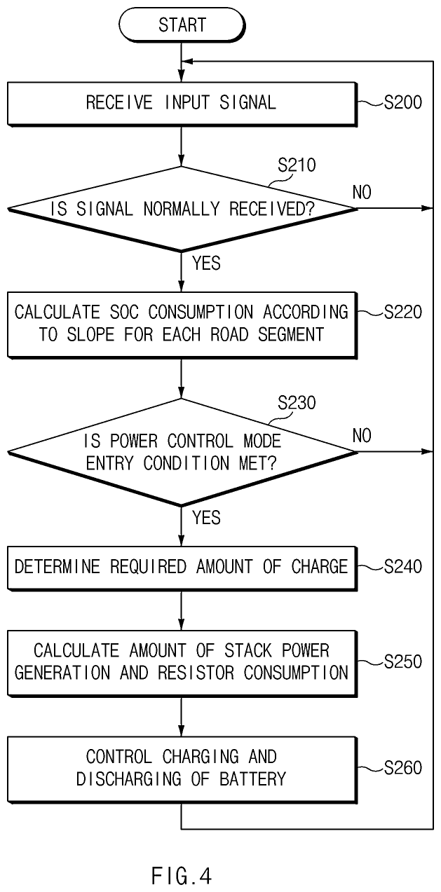

FIG. 4 is a flowchart illustrating a smart power control method according to embodiments of method present disclosure.

In S200, a controller 170 of FIG. 1 may receive an input signal. The controller 170 may receive information (or data) transmitted from a navigation device 110, a map providing device 120, a weight estimation device 130, a fuel cell controller 140, and a battery management device 160 of FIG. 1 as an input signal. The controller 170 may receive vehicle information, road information, recurring driving route information, and/or the like transmitted from the navigation device 110. The vehicle information may include a vehicle speed. The road information may include traffic volume for each road, a vehicle share for each road, a speed for each road, and the like. The controller 170 may receive ADAS map data based on the driving route set by the navigation device 110 from the map providing device 120. The ADAS map data may include slope information for each road segment, a length for each road segment, a distance from the vehicle to each road segment end point, and/or the like. The road segment may be divided around a point where the road slope changes. In other words, the slope in the road segment may be constant within a predetermined acceptable range. The controller 170 may receive estimated vehicle weight information from the weight estimation device 130. The controller 170 may receive fuel cell information including a current amount of stack power generation or the like from the fuel cell controller 140. The controller 170 may receive battery information including a current battery SOC or the like from the battery management device 160.

In S210, the controller 170 may determine whether the signal is normally received. For example, the controller 170 may determine whether there is an error in reception due to a communication failure or the like with the respective components 110 to 160. The controller 170 may determine whether the received input signal is reliable by determining whether the signal is normally received. When it is determined that the signal is normally received, the controller 170 may determine whether the received input signal is reliable. When it is determined that the signal is not normally received, the controller 170 may determine whether the received input signal is not reliable. When it is determined that the input signal is not reliable, the controller 170 may fail to perform smart power control based on a road slope.

In S220, the controller 170 may calculate SOC consumption according to a slope for each road segment (when Yes in S210). When it is determined that the input signal is reliable, the controller 170 may perform the smart power control based on the road slope. When it is determined that the input signal is reliable, the controller 170 may calculate SOC consumption according to the slope for each road segment. At this time, the controller 170 may calculate the SOC consumption according to the slope for each road segment using Equation 4 above. The case where the SOC consumption according to the slope for each road segment is calculated using Equation 4 above is described in the present embodiment but is not limited thereto. The case where the SOC consumption for each road segment is calculated using Equation 3 above may be implemented.

In S230, the controller 170 may determine whether a power control mode entry condition is met. The controller 170 may determine whether the power control mode entry condition is met based on the SOC consumption according to the slope for each road segment in front of the vehicle. When the SOC consumption according to the slope for each road segment meets a first uphill condition control initiation criterion and a second uphill condition control initiation criterion, the controller 170 may determine to enter an uphill condition control mode for power control in an uphill condition. The first uphill condition control initiation criterion and the second uphill condition control initiation criterion may be set by a system designer in advance. For example, when the sum of SOC consumption according to the slope for each road segment, i.e., the sum of SOC consumption according to slopes in first to fifth road segments is greater than the first uphill condition control initiation criterion and when SOC consumption according to the slope in the fifth road segment, the sum of SOC consumption according to the slopes in the fourth road segment and the fifth road segment, the sum of SOC consumption according to the slopes in the third to fifth road segments, or the sum of SOC consumption according to the slopes in the second to fifth road segments is greater than the second uphill condition control initiation criterion, the controller 170 may determine to enter the uphill condition control mode.

Furthermore, when the SOC consumption according to the slope for each road segment meets a first downhill condition control initiation criterion and a second downhill condition control initiation criterion, the controller 170 may determine to enter a downhill condition control mode for power control in a downhill condition. For example, when the sum of SOC consumption according to the slope for each road segment is less than the first downhill condition control initiation criterion and when SOC consumption according to the slope in the fifth road segment, the sum of SOC consumption the slopes in the fourth road segment and the fifth road segment, the sum of SOC consumption according to the slopes in the third to fifth road segments, or the sum of SOC consumption according to the slopes in the second to fifth road segments is less than the second downhill condition control initiation criterion, the controller 170 may determine to enter the downhill condition control mode.

Furthermore, when the power control release time point is reached, the controller 170 may release the uphill condition control or the downhill condition control. When the road segment information is updated, the power control release time point may change. Thus, the power control release time point may be continuously updated on a long ramp. For example, when the controller 170 enters the power control mode by the SOC consumption according to the slope in the fifth road segment, the fifth road segment entry time point may be a power control logic release time point. Furthermore, when the controller 170 enters the power control mode by the sum of SOC consumption according to the slopes in the fourth road segment and the fifth road segment, the fourth road segment entry time point may be a power control logic release time point. When the controller 170 enters the power control mode by the sum of SOC consumption according to the slopes in the third to fifth road segments, the third road segment entry time point may be the power control release time point. When the controller 170 enters the power control mode by the sum of SOC consumption according to the slopes in the second to fifth road segments, the second road segment entry time point may be the power control mode release time point.

When it is determined that the power control mode entry condition is met (Yes in S230), in S240, the controller 170 may determine a required amount of charge. When entering the power control mode, the controller 170 may determine the required amount of charge according to the road slope. As an example, the controller 170 may determine (or calculate) the required amount of charge without regard to an SOC limit by the driving route reliability. In this case, the controller 170 may determine the required amount of charge in the uphill condition as the sum of SOC consumption for each uphill segment. Furthermore, the controller 170 may determine the required amount of charge in the downhill condition as the sum of SOC consumption for each downhill segment. As another example, the controller 170 may determine the required amount of charge with regard to the SOC limit by the driving route reliability. In this case, when the sum of SOC consumption for each uphill segment and the sum of current battery SOCs are less than or equal to the SOC upper limit, the controller 170 may determine the required amount of charge in the uphill condition as the sum of SOC consumption for each uphill segment. Meanwhile, when the sum of SOC consumption for each uphill segment and the sum of current battery SOCs are greater than the SOC upper limit, the controller 170 may determine the required amount of charge in the uphill condition using Equation 5 above. When the sum of SOC consumption for each downhill segment and the sum of current battery SOCs are greater than or equal to the SOC lower limit, the controller 170 may determine the required amount of charge in the downhill condition as the sum of SOC consumption for each downhill segment. When the sum of SOC consumption for each downhill segment and the sum of current battery SOCs are less than the SOC lower limit, the controller 170 may determine the required amount of charge in the downhill condition using Equation 6 above.

In S250, the controller 170 may calculate an amount of stack power generation and resistor consumption using the required amount of charge. The controller 170 may calculate the amount of stack power generation using Equation 7 above in the uphill condition. The controller 170 may calculate the amount of stack power generation using Equation 8 above in the downhill condition. When the amount of stack power generation calculated in the downhill condition is a negative number, the controller 170 may determine the calculated amount of stack power generation as resistor consumption.

In S260, the controller 170 may control charging and discharging of a battery. The controller 170 may control the charging and discharging of the battery based on the amount of stack power generation. The controller 170 may control the fuel cell controller 140 to adjust the amount of stack power generation based on the calculated amount of stack power generation. The controller 170 may charge the battery using electrical energy generated by a fuel cell stack. The controller 170 may control the resistor 150 to consume electrical energy stored in the battery based on the resistor consumption. As the electrical energy is consumed by the resistor 150, the battery may be discharged.

Thereafter, when the battery SOC reaches the SOC limit according to the driving route reliability depending on the power generation of the fuel cell stack, the controller 170 may determine to release the power control.

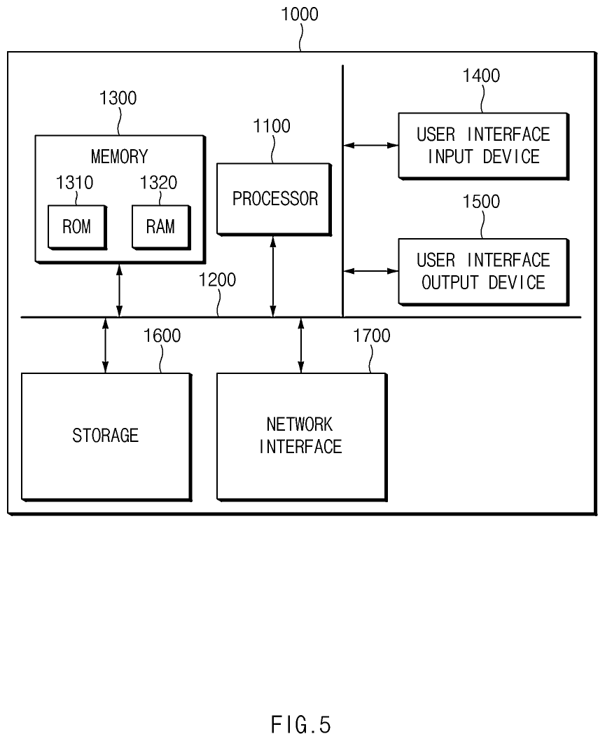

FIG. 5 is a block diagram illustrating a computing system for executing a smart power control method according to embodiments of the present disclosure.

Referring to FIG. 5, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a RAM, a flash memory, a ROM, an EPROM, an EEPROM, a register, a hard disc, a removable disk, and a CD-ROM. The storage medium may be coupled to the processor 1100. The processor 1100 may read out information from the storage medium and may write information in the storage medium. Alternatively, the storage medium may be integrated with the processor 1100. The processor 110 and the storage medium may reside in an application specific integrated circuit (ASIC). The ASIC may reside within a user terminal. In another case, the processor 1100 and the storage medium may reside in the user terminal as separate components.

Embodiments of the present disclosure may perform smart power control by limiting a battery SOC fluctuation range and/or changing a battery charge/discharge rate weight depending on the driving route reliability of the vehicle and thus minimizing a driving problem caused by the smart power control (e.g., deterioration in uphill performance when going uphill or impossibility of braking due to heat generation when going downhill).

Furthermore, embodiments of the present disclosure may determine a battery charge and discharge level depending on the reliability of a route where the vehicle is traveling. Thus, embodiments of the present disclosure may adjust a battery SOC by means of active smart power control even in a situation with high route reliability and thus increase uphill performance and continuously use regenerative braking. Thus, embodiments of the present disclosure may prevent occurrence of a dangerous situation in which uphill performance is degraded when going uphill and it is impossible to brake due to heat generation when going downhill by means of passive smart power control even in a situation with low route reliability.

Hereinabove, although the present disclosure has been described with reference to embodiments and the accompanying drawings, the present disclosure is not limited thereto. The present disclosure may be variously modified and altered by those having ordinary skill in the art to which the present disclosure pertains without departing from the spirit and scope of the present disclosure claimed in the following claims. Therefore, embodiments of the present disclosure are not intended to limit the technical spirit of the present disclosure but provided only for the illustrative purpose. The scope of the present disclosure should be construed on the basis of the accompanying claims, and all the technical ideas within the scope equivalent to the claims should be included in the scope of the present disclosure.

What is claimed is:

1. A smart power control apparatus, comprising:
a navigation device configured to transmit navigation information;
a map providing device configured to transmit map data including slope information; and
a controller connected with the navigation device and the map providing device,
wherein the controller is configured to:
determine driving route reliability for a driving route in front of a vehicle based on the navigation information and the slope information; and
apply at least one of a limit to a battery state of charge (SOC) fluctuation range, an adjustment to a battery charge and discharge rate, or a combination thereof based on the driving route reliability to perform a smart power control.

2. The smart power control apparatus of claim 1, wherein the controller is configured to determine the driving route reliability as a third level when the vehicle travels after a destination is set, when there is only a main path on the driving route, when there is no sub-path having a slope opposite to a slope of the main path, or when there is a combination thereof.

3. The smart power control apparatus of claim 1, wherein the controller is configured to determine the driving route reliability as a second level when a slope of a main path on the driving route is identical to a slope of a first-level sub-path branching from the main path and is opposite to a slope of a second-level sub-path branching from the first-level sub-path, when the driving route is a previously stored recurring driving route, or when there is a combination thereof.

4. The smart power control apparatus of claim 1, wherein the controller is configured to determine the driving route reliability as a first level when the vehicle travels after a destination is not set, when there is a sub-path branching from a main path on the driving route, when there is a sub-path having a slope opposite to a slope of the main path, when the slope of the main path is not identical to a slope of a first-level sub-path branching from the main path but is not identical to a slope of a second-level sub-path branching from the first-level sub-path, and when the driving route does not correspond to a previously stored recurring driving route.

5. The smart power control apparatus of claim 1, wherein the controller is configured to:
calculate SOC consumption according to a slope for each road segment;
determine to enter a power control mode based on the SOC consumption according to the slope for each road segment;
determine a required amount of charge using the SOC consumption according to the slope for each road segment;
calculate an amount of stack power generation using the required amount of charge; and
control charging and discharging of a battery based on the amount of stack power generation.

6. The smart power control apparatus of claim 5, wherein the controller is configured to:
determine to enter an uphill condition control mode for power control in an uphill condition, when the SOC consumption according to the slope for each road segment meets an uphill condition control initiation criterion; and
determine to enter a downhill condition control mode for power control in a downhill condition, when the SOC consumption according to the slope for each road segment meets a downhill condition control initiation criterion.

7. The smart power control apparatus of claim 6, wherein the controller is configured to determine a time point when the vehicle enters a road segment closest to the vehicle among road segments meeting the uphill condition control initiation criterion and the downhill condition control initiation criterion as a power control release time point.

8. The smart power control apparatus of claim 5, wherein the controller is configured to:
control a fuel cell controller to adjust the amount of stack power generation based on the amount of stack power generation; and
charge the battery with electrical energy generated by a fuel cell stack.

9. The smart power control apparatus of claim 5, wherein the controller is configured to determine the amount of stack power generation as resistor consumption, when the amount of stack power generation is a negative number.

10. The smart power control apparatus of claim 9, wherein the controller is configured to control a resistor to consume electrical energy stored in the battery based on the resistor consumption.

11. A smart power control method, comprising:
determining driving route reliability for a driving route in front of a vehicle based on navigation information and slope information included in map data; and
applying at least one of a limit to a battery state of charge (SOC) fluctuation range, an adjustment to a battery charge/discharge rate, or a combination thereof based on the driving route reliability to perform a smart power control.

12. The smart power control method of claim 11, wherein the determining of the driving route reliability includes:
determining the driving route reliability as a third level when the vehicle travels after a destination is set, when there is only a main path on the driving route, when there is no sub-path having a slope opposite to a slope of the main path, or when there is a combination thereof.

13. The smart power control method of claim 11, wherein the determining of the driving route reliability includes:
determining the driving route reliability as a second level, when a slope of a main path on the driving route is identical to a slope of a first-level sub-path branching from the main path, but is opposite to a slope of a second-level sub-path branching from the first-level sub-path, when the driving route is a previously stored recurring driving route, or when there is a combination thereof.

14. The smart power control method of claim 11, wherein the determining of the driving route reliability includes:
determining the driving route reliability as a first level when the vehicle travels after a destination is not set, when there is a sub-path branching from a main path on the driving route, when there is a sub-path having a slope opposite to a slope of the main path, when the slope of the main path is not identical to a slope of a first-level sub-path branching from the main path but is not identical to a slope of a second-level sub-path branching from the first-level sub-path, and when the driving route does not correspond to a previously stored recurring driving route.

15. The smart power control method of claim 11, wherein the controlling of the smart power control includes:
calculating SOC consumption according to a slope for each road segment;
determining to enter a power control mode based on the SOC consumption according to the slope for each road segment;
determining a required amount of charge using the SOC consumption according to the slope for each road segment;
calculating an amount of stack power generation using the required amount of charge; and
controlling charging and discharging of a battery based on the amount of stack power generation.

16. The smart power control method of claim 15, wherein the determining to enter the power control mode includes:
determining to enter an uphill condition control mode for power control in an uphill condition, when the SOC consumption according to the slope for each road segment meets an uphill condition control initiation criterion; and
determining to enter a downhill condition control mode for power control in a downhill condition, when the SOC consumption according to the slope for each road segment meets a downhill condition control initiation criterion.

17. The smart power control method of claim 16, wherein the determining to enter the power control mode further includes:
determining a time point when the vehicle enters a road segment closest to the vehicle among road segments meeting the uphill condition control initiation criterion and the downhill condition control initiation criterion as a power control release time point.

18. The smart power control method of claim 15, wherein the controlling of the charging and discharging of the battery includes:
controlling a fuel cell controller to adjust the amount of stack power generation based on the amount of stack power generation; and
charging the battery with electrical energy generated by a fuel cell stack.

19. The smart power control method of claim 15, wherein the calculating of the amount of stack power generation includes:
determining the amount of stack power generation as resistor consumption, when the amount of stack power generation is a negative number.

20. The smart power control method of claim 19, wherein the controlling of the charging and discharging of the battery includes:
controlling a resistor to consume electrical energy stored in the battery based on the resistor consumption.
